(19) United States
(12) Patent Application Publication
(10) Pub. No.: US 2013/0257590 A1
(43) Pub. Date: Oct. 3, 2013

(54) METHODS AND SYSTEMS FOR AN AUTHENTICATING LOCK WITH BAR CODE

(71) Applicant: ONITY, INC., Duluth, GA (US)

(72) Inventors: Adam L. Kuenzi, Silverton, OR (US); Alberto Vecchiotti, Atlanta, GA (US); Frank R. Dyer, Duluth, GA (US); R. Steve Switzer, Atlanta, GA (US)

(73) Assignee: ONITY, INC., Duluth, GA (US)

(21) Appl. No.: 13/851,440

(22) Filed: Mar. 27, 2013

Related U.S. Application Data
(60) Provisional application No. 61/618,445, filed on Mar. 30, 2012.

(51) Int. Cl. G05B 1/01

(52) U.S. Cl. CPC G05B 1/01
USPC 340/5.65

(57) ABSTRACT

Exemplary embodiments provide systems and methods for opening electronic locks employing an image, such as the image of a bar code, (e.g., a QR code), and using the hardware and software resources commonly found on a mobile device such as a cell phone or tablet computer. An application on the mobile device obtains information identifying a lock, such as a series of numbers displayed by the lock or encoded in a bar code on the lock, and inputs it along with information identifying a particular user to an algorithm that generates a key code for the lock. The application on the mobile device displays the key code (e.g., as a numeric code or embedded in a bar code image) and the lock receives the displayed key code and opens. In various embodiments, the key code may be entered into a control interface on the lock, or captured by a camera connected to the lock.

### CROSS-REFERENCE TO RELATED APPLICATIONS

This application claims the benefit of, and priority to, U.S. Provisional Patent Application Ser. No. 61/618,445, filed on Mar. 30, 2012, which is incorporated herein by reference in its entirety.

### FIELD

This disclosure relates to locks, and more particularly, to employing an image, such as an image of a bar code, (e.g., a quick response (QR) bar code), to authenticate a user and open an electronic lock.

### BACKGROUND

Typically, electronic locks, including electro-mechanical locks, such as those found on hotel room doors, office suite doors, etc. are unlocked or opened using data from a card reader that reads a magnetic swipe card or a secure smart card, perhaps including an RF transceiver. Less commonly, electronic locks are opened using a biometric reader (e.g., a fingerprint reader), or smart phone eKey™ technology communicating with the lock over a Bluetooth® or Infrared Data Association (IrDA) communication link, for example, as developed by the Supra subsidiary of UTC Fire & Security Corp. of Farmington Conn.

One drawback of some existing key technologies for electronic locks, such as swipe card authentication, is that they require the user to ‘have something’ or ‘get something’ that the user does not ordinarily have, like a hotel key smart card, before the user can open the lock. Another drawback of some existing key technologies, such as biometric authentication, is that they require an expensive, smart, networked lock with specialized hardware (e.g., fingerprint reader) and specialized processing (e.g., matching of fingerprint data). Yet another drawback of some existing key technologies is that they are slow, making them difficult for the user to use in a high-volume or high-use way. For example, opening an electronic lock utilizing Bluetooth® from a smart phone may take several seconds, with delays cause by all the communications between the phone and the lock and other locations, including “report back” communications to note a lock opening to a central person or system via wi-fi or RF from the lock or via the telephone network from the phone. Another drawback of existing smart-phone-based technologies is that they require the phone to have specialized hardware and/or software that is not ubiquitous. For example, many phones lack a Bluetooth® transceiver, and many phones lack the specific operating system needed to run applications like the eKey™ application.

The present disclosure provides several novel improvements to electronic key and lock systems that allow opening of an online or offline, battery powered lock with convenient, ubiquitous, easy-to-use hardware, such as a mobile phone that has a display screen, yet still includes report back communications to note a lock opening to a central person or system. The present disclosure also provides improvements that allow a lock-opening transaction to occur in a short amount of time, and improvements that can provide “one-way” opening techniques, where the lock is opened by a device such as a smart phone or key card, and the phone or card doesn't know that it did anything, and therefore does not report back regarding lock openings.

### SUMMARY OF THE DISCLOSURE

The present disclosure describes, among other things, methods that may be used for opening an electronically controlled lock by a user. One implementation of a method may be performed by a mobile device running an application that performs operations including obtaining user information that identifies the user, obtaining lock information that identifies the electronically controlled lock, creating key information based on the user information and the lock information, and displaying the key information on a mobile device. In such implementations, the electronically controlled lock may receive the key information and process it to open the electronically controlled lock.

Other variants include non-transitory computer-readable media (such as a storage device on a server or in a mobile device) that have instructions that, when executed by a processor, such as the processor on a mobile device, implement operations that allow a user to open an electronically controlled lock. In various implementations, the instructions perform operations that include obtaining user information that identifies the user, obtaining lock information that identifies the electronically controlled lock, creating key information based on the user information and the lock information, and displaying the key information on a mobile device. In such implementations, the electronically controlled lock may receive the key information and process it to open the electronically controlled lock.

Still other variants described include an electronic lock that interacts with the previous variants. Some such electronic locks may comprise a display that includes lock information that identifies the electronic lock to a mobile device, a key information receptor that receives key information displayed by the mobile device, and a processor, operably connected to the key information receptor. In such variants, the processor may determine whether the key information is currently valid for opening the electronic lock, and the lock may also include a lock actuator circuit, operably connected to the processor, that opens the electronic lock based on a signal from the processor indicating that the key information is currently valid for opening the electronic lock.

### BRIEF DESCRIPTION OF THE DRAWINGS

The accompanying drawings, which are incorporated in and constitute a part of this specification, illustrate embodiments of the invention and together with the description, serve to explain the principles of the invention. Wherever convenient, the same reference numbers have been used to refer to the same or similar components. In the figures:

FIG. 1 illustrates an exemplary system and process for an authenticating lock that uses an image of a bar code, consistent with embodiments of the invention;

FIG. 2 illustrates another exemplary system and process for an authenticating lock that uses an image of a bar code, consistent with embodiments of the invention;

FIG. 3 illustrates another exemplary system and process for an authenticating lock that uses an image of a bar code, consistent with embodiments of the invention;

FIG. 4 is a block diagram of an exemplary system for implementing various lock and key embodiments consistent with the invention; and

FIG. 5 is a block diagram of an exemplary computing or data processing system that may be used to implement embodiments of electronic devices that are consistent with the invention.

### DESCRIPTION OF EMBODIMENTS

In general, embodiments consistent with the present disclosure provide systems and methods that provides for a very convenient way to open electronic locks employing an image, such as the image of a bar code, (e.g., a QR code), and using hardware and software resources commonly found on any cell phone or tablet computer. For example, some embodiments require only that the cell phone have the ability to run a software application and display images. Other embodiments require the ability to take a picture, and/or the ability to enter characters into the application. Various embodiments also provide communication of a positive indication of lock opening. Various embodiments can be made non-transferrable by securing the application on the phone.

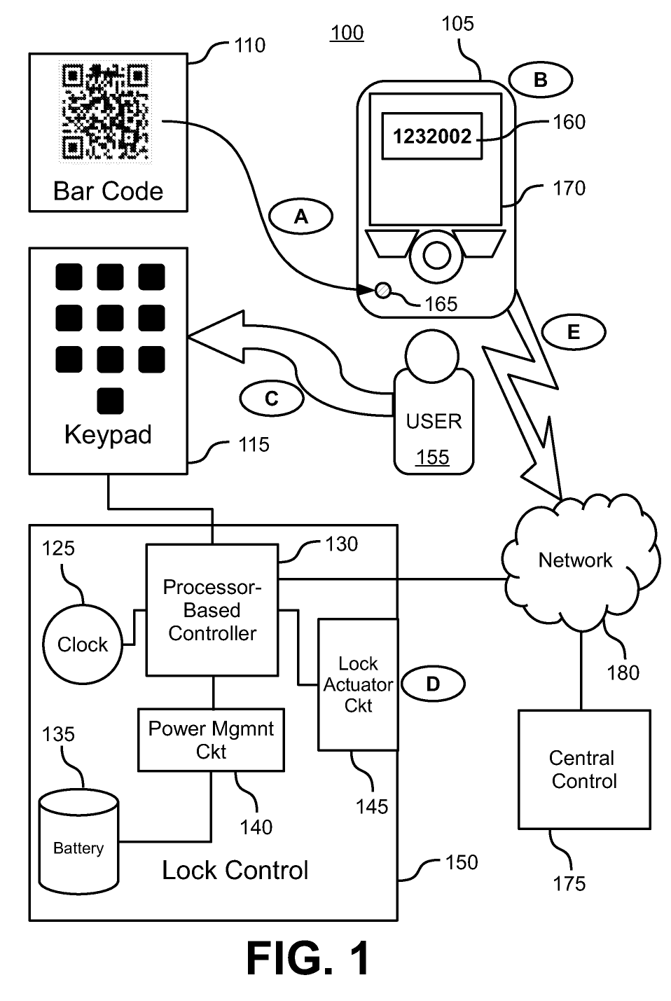

For example, FIG. 1 illustrates an exemplary system and process 100 for an authenticating lock that uses an image of a bar code, consistent with embodiments of the invention. In the embodiment shown, system 100 includes a lock control 150 that controls the operation of an electric lock, such the lock on a hotel room door, the lock on the door to a building or office, the lock on a safe door, the lock on a cabin door, a vehicle ignition lock, and the like. As shown in this exemplary embodiment, lock control 150 includes a processor-based controller 130, which may include a CPU, or the like, and associated circuitry, and interfaces that connect to and interoperate with other components, including other components of lock control 150.

As shown, processor-based controller 130 is operably connected to a clock 125, which may be a real-time clock, and to a power management circuit 140, which is in turn connected to a battery 135. Processor-based controller 130 is also connected to a lock actuator circuit 145, which operates to open and/or close a lock or similar mechanism (not shown), such an electro-mechanical door lock or the like. Processor-based controller 130 may also be connected to a network 180 and to a central control 175 via network 180. Network 180 may be any type of network that allows transfer of data, such as lock-opening code (e.g., a sequence of characters) from central control 175 to lock control 150, including, for example, a LAN, WAN (e.g., the Internet), wired network, wireless network, hybrid wired/wireless network (including a cellular telephone network), and the like. Central control 175 may include a property management system, as is known in the art.

In the embodiment shown, processor-based controller 130 is also connected to a keypad 115. In various embodiments, processor-based controller 130 may operate to open and/or close a lock (not shown) that is connected to lock actuator circuit 145 when a specific sequence of keys is pressed on keypad 115. The operation and functionality of lock control 150 and keypad 115 are well known to those of skill in the art, (for example, as exemplified by the Code Pro™ lock system produced by the Onity Company, which is part of UTC Fire & Security of CT) and need not be explained further.

Exemplary system 100 also includes a bar code image 110 that is visible to or accessibly by a user 155 with a mobile device 105, which may be most any processor-based, portable device having the hardware and software resources described herein. Examples of mobile device 105 include a mobile phone or cell phone, smart phone, tablet computer, portable gaming system, portable music player, personal digital assistant, and the like. In various embodiments, barcode image 110 may be in any form that allows barcode image 110 to be photographed, scanned, or read by an image capturing device 165 included with mobile device 105, such as a camera on a cell phone or the like. For example, barcode image 110 may be in the form of a wall painting, sticker, decal, sign, poster, card, paper, projection, display screen, LCD display, or the like. In various embodiments, barcode image 110 may be displayed in the vicinity of keypad 115 and/or in the vicinity of or in association with a lock (not shown) that is controlled by lock actuator circuit 145, and barcode image 110 may contain information identifying the lock (not shown).

In addition to image capturing device 165, mobile device 105 may also include a display screen 170, such as a touch screen, LCD screen or the like, and mobile device 105 may be capable of executing a software application or program that implements functions consistent with this disclosure. In some embodiments, mobile device 105 may be a smart phone, such as an Apple iPhone™ or a Motorola Droid™, or the like; or a tablet computer, such as an Apple iPad™, Apple iPod Touch™, or an Amazon Kindle™, or the like. As shown, a software application running on mobile device 105 may process barcode image 110 as captured by image capturing device 165 (perhaps in combination with information identifying user 155 that was stored beforehand) and display a series of characters 160, such as numbers, on display screen 170 in response to, and/or generated using, the captured barcode image 110. As explained in further detail below, user 155 may read the series of characters 160 on display screen 170 and then enter them on keypad 115 in order to open a lock controlled by lock control 150, where the series of characters 160 act as a key code.

System 100 further includes a central control 175, which may occasionally communicate wirelessly with mobile device 105 via a network 180, including bi-directional communications. In some embodiments central control 120 may be implemented as one or more servers or other computers that implement an access control for areas secured by locks, such a property management system for a hotel, or the like. In various embodiments, the software application running on mobile device 105 may communicate to central control 175 data related to the functions described in this disclosure, such as data indicating that barcode image 110 has been photographed or otherwise captured by image capturing device 165, data indicating that series of characters 160 has been displayed on display screen 170, and/or data indicating other functions related to this disclosure have been performed. Similarly, central control 175 may communicate to mobile device 105 data related to the functions described in this disclosure, such as data representing the expected appearance of barcode image 110, data representing the series of characters 160, data (such as information that identifies user 155) to be input to an algorithm for generating the series of characters 160, and the like.

Referring now to the ovals containing capital letters shown in FIG. 1, an example of a process for operating a lock using an image, consistent with embodiments of the invention, will be described. As represented by the arrow below oval A, an image associated with and/or identifying a lock, such as barcode image 110, is read, scanned, photographed, or otherwise obtained by image capturing device 165 of mobile device 105.

Next, an application, software program, or the like, running on mobile device 105 processes the data represented by or contained in barcode image 110 to generate a series of characters 160 that act as key information, as represented by oval B. In some embodiments, the application may calculate the series of characters 160 without communicating with central control 175, wherein the output of the calculation is dependent on information contained in barcode image 110 in combination with the time of day and/or perhaps other variables, which may include user-information variables obtained beforehand from central control 175. In such embodiments, processor-based controller 130 may perform a similar calculation using the time of day from clock 125 and/or perhaps other variables in order to determine the series of characters 160 that processor-based controller 130 will accept to open a lock controlled by lock actuator circuit 145. In other embodiments, the application on mobile device 105 may communicate with central control 175 in order to obtain information (e.g. user-identifying information) or variables needed to calculate series of characters 160, or the application on mobile device 105 may receive series of characters 160 from central control 175. In yet other embodiments, series of characters 160 may be generated by, or series of characters 160 may have been previously stored by, or data allowing the application running mobile device 105 to generate series of characters 160 may be communicated by, central control 175, in anticipation of user 155 opening a lock controlled by lock system 150. For example, a different series of characters 160 may be generated successively for each of the guests/users who successively check in to a hotel room over time. Other techniques for generating the series of characters 160 may also be used.

As represented by oval C, the user 155 types the series of characters 160, which may be a numeric key code, into keypad 115. Next, processor based controller 130 validates the typed-in series of characters 160, and if they are correct (i.e., if they are a “key code”), causes lock actuator circuit 145 to open the lock, as represented by oval D.

In some embodiments, as represented by oval E, the application on mobile device 105 may optionally send a message or data to central control 175 via network 180 indicating that the lock associated with bar code image 110 had been opened or accessed by mobile device 105, which is associated with user 155. In various such embodiments, the application on mobile device 105 may send the time of access with the message or data. In various such embodiments, the application on mobile device 105 may send the message or data to central control 175 when bar code image 110 is read, or it may send the message or data at a later time.

One of ordinary skill will recognize that elements, features, stages and functionality may be added to, removed from, or modified for the system and process shown in FIG. 1, without departing from the principles of the invention. For example, a magnetic card reader could be connected to lock control 150, allowing the lock controlled by lock control 150 to be opened with a conventional magnetic card as well as with the technique just described. For yet another example, lock actuator circuit 145, and the associated lock that it controls, could be replaced with numerous other types of actuator circuitry and associated controlled device(s), such as a vehicle (e.g., automobile, boat, etc.) starter, a vending machine dispenser, etc.

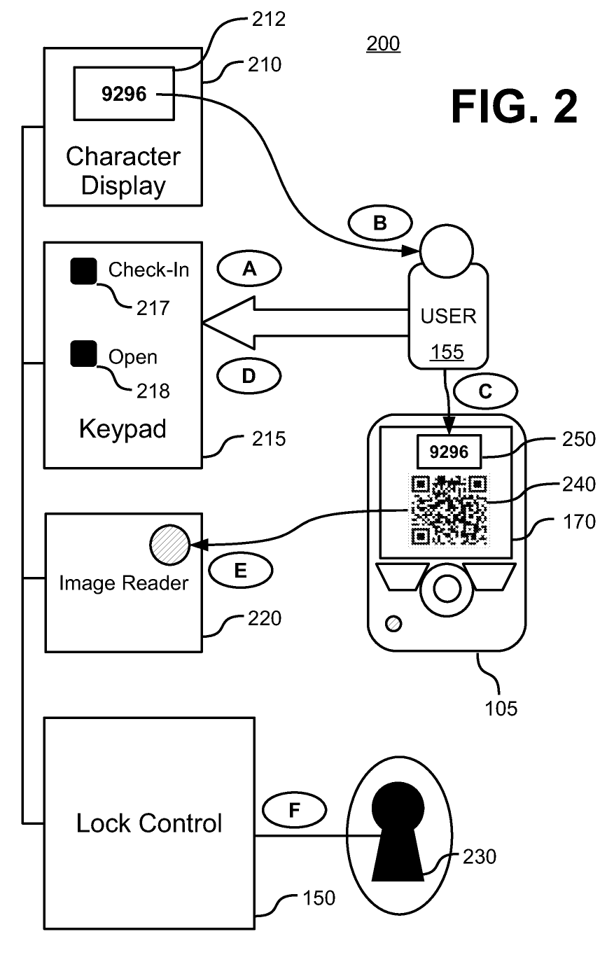

FIG. 2 is a diagram of an exemplary system and process 200 for an authenticating lock that uses an image of a bar code, consistent with embodiments of the invention. In the embodiment shown, system 200 includes a lock control 150 that controls the operation of a lock 230, such as an electric lock, an electro-mechanical lock, or the like. As shown in this exemplary embodiment, lock control 150 may be as described with respect to FIG. 1. In various embodiments, system 200 may include a network 180 (not shown in FIG. 2) and central control 175 (not shown), as described with respect to FIG. 1.

As shown in the embodiment of FIG. 2, lock control 150 is operably connected to a character display 210, which may display a series of characters 212, which may include numerals, supplied to character display 210 by lock control 150. The series of characters 212 may be associated with or identify lock 230, as distinguished from other locks. Character display 210 may be any type of variable display that is readable by a user 155, such as an LCD display, an LED display, and the like. In various embodiments, character display 210 may be mounted in close proximity or association to lock 230, so that user 155 can conveniently access whatever is secured by lock 230 (e.g., a hotel room door) soon after reading character display 210.

As shown, lock control 150 is also operably connected to a keypad 215. In various embodiments, lock control 150 may operate to perform different functions depending on which specific key of keypad 215 is pressed by user 155. In the embodiment shown, keypad 215 includes a check-in key 217 and an open key 218. In various embodiments, when check-in key 217 is pressed, lock control 150 sends character data to character display 210, which displays the corresponding characters (e.g., lock identification information represented by series of characters 212) to user 155; and when open key 218 is pressed, lock control 150 controls an image reader 220 to capture an image of a something positioned by user 155 for reading by image reader 220, such as an image of a “key” bar code 240. In various embodiments, keypad 215 may be mounted in close proximity to character display 210 and to lock 230.

As just noted, lock control 150 is also operably connected to image reader 220. In various embodiments, image reader 220 may include a camera, a digital scanner, or the like, and image reader 220 may be mounted in close proximity to character display 210, keypad 215, and lock 230. Also as just noted, in various embodiments, when open key 218 is pressed, lock control 150 may control image reader 220 to capture an image of a something, such as an image of a key bar code 240. In various embodiments, lock control 150 may operate to open and/or close lock 230 if processing of the captured image indicates that the image represents or contains valid “key” information to open lock 230. In embodiments where the captured image is the image of a bar code, such as key bar code 240, lock control 150 may extract key information from the barcode, and open lock 230 if the key information from the barcode matches the current key code for lock 230. In reserved-resource type implementations, similar to the technique explained with respect to FIG. 1, a different key bar code 240 may be required by lock control 150 for each successive user who rents a resource secured by lock 230, with key bar codes activated and deactivated as each user checks in and out over time, (for example, to a hotel room, ship's cabin, rental car, etc.).

As shown in exemplary system 200 of FIG. 2, a mobile device 105, such as a mobile phone, smart phone, tablet computer, or the like, may be associated with user 155 and employed by system 200. As shown, mobile device 105 may include a display screen 170, such as a touch screen, LCD screen or the like, and mobile device 105 may be capable of executing a software application or program that implements functions consistent with this disclosure. In some embodiments, mobile device 105 may be a smart phone, such as an Apple iPhone™ or a Motorola Droid™, or the like; or a tablet computer, such as an Apple iPad™ or an Amazon Kindle™, or the like.

In various embodiments, a software application running on mobile device 105 may accept a series of characters 212 input into a user interface 250 by user 155 after reading the series of characters 212 associated with or identifying lock 230 from character display 210. In such embodiments, the software application may process the entered characters from user interface 250, (perhaps in combination with other information, such as user-identity information) to generate an image of a key bar code 240 on display screen 170. As explained in further detail below, user 155 may then position mobile device 105 where display screen 170 can be photographed, read, or scanned, etc. by image reader 220, so that image reader 220 captures an image of key barcode 240. In various embodiments, the software application running on mobile device 105 may also communicate with a central control (not shown), as described with respect to FIG. 1.

Referring now to the ovals containing capital letters shown in FIG. 2, an example of a process for operating a lock using an image, consistent with embodiments of the invention, will be described. As represented by the arrow below oval A, the process may begin with user 155 pressing check-in button 217 on keypad 215.

In response, character display 210 may display a series of characters 212 identifying lock 230 to user 155, as represented by the arrow below oval B. In various embodiments, series of characters 212 may be generated by, or may have been previously communicated to and stored by, lock control 150, and series of characters 212 may be random or may have been uniquely prepared for display to user 155 (i.e., to be entered into an application running on the mobile device 105 of user 155), in anticipation of user 155 opening lock 230. In such embodiments, a different series of characters 212 may be generated successively for each of a series of users—for example, guests who successively check in to a hotel room over time.

As represented by arrow next to oval C, user 155 may enter the series of characters 212 identifying lock 230 into their mobile device 105, for example, via a user interface 250 to a software application running on mobile device 105. In various embodiments, upon receiving the series of characters 212, the application running on mobile device 105 may use the series of characters 212, perhaps in conjunction with pre-downloaded user credential information, to generate a key bar code 240 containing information for opening lock 230, such as a QR bar code, and to display the key bar code 240 on display screen 170 of mobile device 105.

As represented by the arrow above oval D, after display of key bar code 240, user 155 may press open button 218 of keypad 215, sending a control signal to lock control 150. In response, lock control 150 may activate image reader 220, which captures (e.g. photographs) an image of key barcode 240 on display screen 170 as user 155 holds mobile device 105 in a position that allows image reader 220 to properly capture the image, as represented by the arrow above oval E.

As represented by oval F, lock control 150 processes the captured image of key bar code 240 to determine if it contains the proper authorization information or key information. If the bar code is a “key,” i.e., if it contains the proper authorization/key information that lock control 150 expects, then lock control 150 opens lock 230.

In various embodiments, if user 155 subsequently wishes to open lock 230, user 155 may display key bar code 240 on mobile device 105, press only the open button 218 and scan key bar code 240 into image reader 220 to unlock lock 230. In such embodiments, lock control 150 may be configured to recognize key bar code 240 as a virtual key for a specific period of time (e.g., for the length of time that a hotel-guest user 155 has reserved a room) or until key bar code 240 is deactivated as a virtual key for lock 230 (e.g., until user 155 checks out of a hotel and a central control system communicates with lock control 150 to change the key information, which cancels key bar code 240 as a virtual key).

In some embodiments, upon entry of a series of characters 212 that identify lock 230 and serve as a check-in code into the application running on mobile device 105, mobile device 105 may send a message or data to a central control indicating that user 155 has checked in and/or opened lock 230.

One of ordinary skill will recognize that elements, features, stages and functionality may be added to, removed from, or modified for the system and process shown in FIG. 2, without departing from the principles of the invention. For example, a magnetic card reader could be connected to lock control 150, allowing lock 230 to be opened with a conventional magnetic card, as well as by using an image. For yet another example, lock control 150 and lock 230 could be replaced with numerous other types of access control circuitry that operates in a similar manner but controls devices and systems other than locks, such as vehicle ignition systems, product dispensing devices, etc.

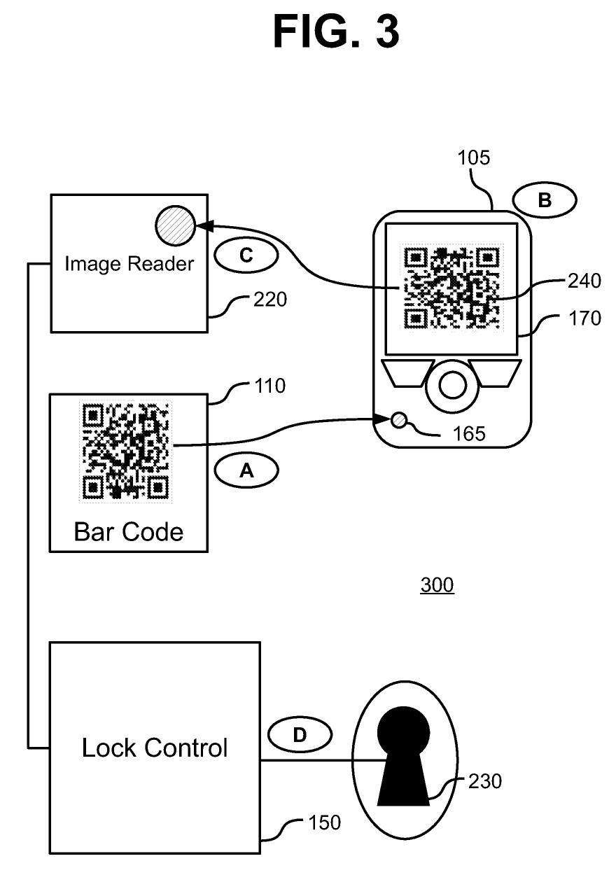

FIG. 3 illustrates an exemplary system and process 300 for an authenticating lock that uses an image of a bar code, consistent with embodiments of the invention. In the embodiment shown, system 300 includes a lock control 150 that controls the operation of a lock 230, such as an electric lock, an electro-mechanical lock, and the like. As shown in this exemplary embodiment, lock control 150 may be as described with respect to FIGS. 1 and 2. In various embodiments, system 300 may also include a network 180 (not shown in FIG. 2) and central control 175 (not shown), as described with respect to FIG. 1.

Exemplary system 300 includes a bar code image 110 that is visible to or accessibly by a user (not shown) with a mobile device 105, such as mobile phone, smart phone, tablet computer, or the like. In various embodiments, barcode image 110 may be in any form that allows barcode image 110 to be photographed, scanned, or read by an image capturing device 165, which may be included with mobile device 105, such as a camera on a cell phone or the like. For example, barcode image 110 may be in the form of a wall painting, sticker, decal, sign, poster, card, paper, projection, display screen, LCD display, or the like. In various embodiments, barcode image 110 may be displayed in the vicinity of an image reader 220 and/or in the vicinity of or in association with a lock 230 that is controlled by a lock control 150. In various embodiments, barcode image 110 contains information that identifies lock 230.

As shown in the embodiment of FIG. 3, lock control 150 is operably connected to the image reader 220. In various embodiments, image reader 220 may include an analog or digital camera, a digital scanner, or the like, and image reader 220 may be mounted in close proximity to lock 230 and bar code 110. In various embodiments, image reader 220 may operate to capture an image of anything positioned next to image reader 220, such as an image of a “key” bar code 240 when a mobile device 105 displaying key bar code 240 is held next to image reader 220. In some embodiments a control (not shown), such as a button or keypad key, may be operably connected to image reader 220 such that image reader 220 captures an image only when the control is activated. In various embodiments, lock control 150 may operate to open and/or close lock 230 if processing of an image captured by image reader 220 indicates that the image is a valid “key” to lock 230 (e.g., if the image contains valid key information that opens lock 230). In embodiments where the captured image is the image of a bar code, such as key bar code 240, lock control 150 may extract key information from the barcode, and open lock 230 if the key information from the barcode matches a current key code for lock 230.

In various embodiments, lock 230 may control access to an area (such as, for example, a hotel room, a cruise ship cabin, an office, an automobile's interior, etc.), or to a device or a functionality of a device (such as, for example, a rented vehicle's starting or ignition system, a dispensing function of a vending machine, etc.).

As shown in exemplary system 300 of FIG. 3 and noted above, a mobile device 105 may be employed by system 300. As shown, mobile device 105 may include a display screen 170, such as a touch screen, LCD screen or the like, and mobile device 105 may be capable of executing a software application or program that implements functions consistent with this disclosure. In some embodiments, mobile device 105 may be a smart phone, such as an Apple iPhone™ or a Motorola Droid™, or the like; or a tablet computer, such as an Apple iPad™ or an Amazon Kindle™, or the like.

In various embodiments, a software application running on mobile device 105 may process an image of bar code 110 captured by an image capturing device 165 for mobile device 105 to extract lock-identifying information. In such embodiments, the software application may process the information in barcode 110, perhaps in combination with information downloaded or otherwise stored in mobile device 105 (such as user authentication information), to generate a display of an image containing lock-opening information, such as key barcode 240 (which is different than bar code 110) on display screen 170. As explained in further detail below, a user (not shown) may then position mobile device 105 where display screen 170 can be photographed, read, or scanned, etc. by image reader 220, so that image reader 220 captures an image of key barcode 240 for processing. In various embodiments, the software application running on mobile device 105 may communicate with a central control (not shown), as described with respect to FIG. 1.

Referring now to the ovals containing capital letters shown in FIG. 3, an example of a process for operating lock 230 using an image, consistent with embodiments of the invention, will be described. As represented by the arrow above oval A, the process may begin when a user (not shown) activates image capturing device 165 of mobile device 105 to photograph, scan, or otherwise record an image of bar code 110 associated with and/or identifying lock 230. In some embodiments, an application executing on mobile device 105 may control image capturing device 165 and automatically receive as input the recorded image of bar code 110. In other embodiments, image capturing device 165 may not be controlled by the application described in this disclosure, and instead, a user (not shown) may activate image capturing device 165 independently, and provide the captured image to the application that generates a key barcode 240, as described in this disclosure.

Next, as represented by oval B, the software application executing on mobile device 105 processes the recorded image of bar code 110 to generate a “key” image, in this example an image of key barcode 240, and display it on display screen 170. In various embodiments, the application may also use pre-downloaded authentication/identity data associated with the user/owner of mobile device 105 (e.g., authentication data gathered from the user when the user made a reservation) to generate key bar code 240, which may contain some or all of the authentication data, or data derived therefrom. In various embodiments, this same information, or data derived therefrom, may be used to generate the key information that lock control 150 expects to receive in order to open lock 230.

In some embodiments, in response to receiving the recorded image of bar code 110, the application executing on mobile device 105 also sends a message or data to a central control (not shown) (e.g., via a cellular telephone or wifi network (not shown)) indicating that lock 230 is, or will be opened by a user/owner associated with mobile device 105. In some embodiments, the message or data may include the date and time when the image of bar code 110 was captured by mobile device 105.

Next, as represented by the arrow above oval C, the process continues when mobile device 105 is positioned near image reader 220 such that image reader 220 can capture or record an image of key bar code 240, which is displayed on display screen 170. As shown, image reader 220 is connected to lock control 150, so as to provide the captured image of key bar code 240 to lock control 150.

In the final stages of the process, lock control 150 processes the image of key bar code 240, and if key bar code 240 contains the correct key information expected by lock control 150 (e.g., the correct key code), (which may, for example, be provided by, or calculated from information provided by, a central control 175 (e.g., a property management system)) then lock control 150 opens lock 230. If key bar code 240 does not contain the correct key information expected by lock control 150, then lock control 150 does not open lock 230.

In various embodiments, if a user (not shown) subsequently wishes to open lock 230, user 155 may display key bar code 240 on mobile device 105 and scan key bar code 240 into image reader 220 to unlock lock 230. In such embodiments, lock control 150 may be configured to recognize key bar code 240 as a “key” for a specific period of time (e.g., for the length of time that a user has rented an automobile) or until bar code 240 is deactivated as a key for lock 230 (e.g., until the user checks out of a hotel and a central control system communicates with lock control 150 to change the key information, which effectively cancels key bar code 240 as a key).

One of ordinary skill will recognize that elements, features, stages and functionality may be added to, removed from, or modified for the system and process shown in FIG. 3, without departing from the principles of the invention. For example, a magnetic card reader could be connected to lock control 150, allowing lock 230 to be opened with a conventional magnetic card, as well as by using an image. For yet another example, lock control 150 and lock 230 could be replaced with numerous other types of access control circuitry that operates in a similar manner but controls devices and systems other than locks, such as vehicle ignition systems, product dispensing devices, etc. For yet another example, images of something other than a bar code may be used in system 300, including any image that can convey or encode information that identifies or is associated with a particular user 155 and/or a particular lock 230.

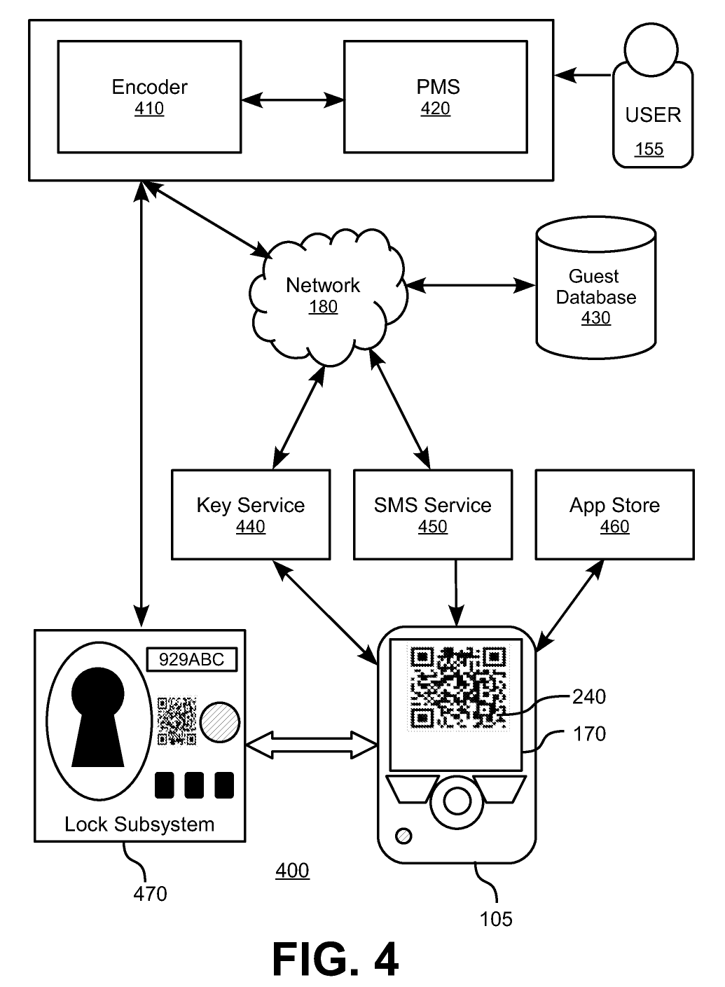

FIG. 4 is a block diagram of an exemplary system 400 suitable for implementing various embodiments consistent with the invention. As shown in this example, system 400 includes a property management system (PMS) 420, as is known in the art. In various embodiments, PMS 420 may be a computerized system used to manage guest bookings, online reservations, point of sale transactions, telephone and other amenities at a property such as a hotel, motel, cruise ship, etc. As shown, a user 155 who desires to be or is currently a guest at the property (e.g., a hotel guest), interacts with PMS 420, either directly (e.g., via a website) or indirectly (e.g., via an employee of the property), to make reservations, check in, check out, etc., as is known in the art.

In the embodiment shown, PMS 420 is operably connected to an encoder 410, which may be a device or subsystem that typically functions to place key information (e.g., a key code) onto an access device (not shown), such as a magnetic-strip room access card (not shown), an RF access device (not shown), or the like, for room-access use by a property guest, as is known in the art.

PMS 420 may also be connected to a guest database 430, perhaps via a network 180 as shown in this example. Guest database 430 stores information related to people who have reserved resources (e.g., a hotel room) for future use at a property and/or who are current guests at a property, such as identity information, address information, rate and charges information, date of stay information, check-in time information, credit card information, and the like, as is known in the art.

In the embodiment shown, encoder 410 may be communicatively connected to lock subsystem 470, and may transfer the current key code (or information enabling calculation of the current key code) to lock subsystem 470 so that a guest with the corresponding access device having the same key code can unlock or open the lock to their room, as is known in the art. In the embodiment shown, lock subsystem 470 may include one or more of the functions, devices, and features associated with lock control 150 as shown in the exemplary embodiments of FIGS. 1-3.

In various embodiments consistent with the present disclosure, PMS 420 and encoder 410 include new functionality not found in conventional systems. For example, the key information generated by encoder 410 (or information enabling calculation of the key information) may be communicated to a key service 440 via a network 180, which may include the Internet. In various embodiments the key information (e.g., key code) may incorporate, or be a function of, information associated with and/or identifying a guest, such as a home address, mobile phone number, credit card number, dates of stay, reservation number, etc., and/or information associated with or identifying lock subsystem 470, all or part of which may be stored in guest database 430. Such embodiments may employ an algorithm that uses as input all or part of the information associated with or identifying a guest, along with other input information, such as information contained in a barcode associated with or identifying a specific lock subsystem 470 (e.g., barcode 110) and/or numerical information displayed in association with or identifying a specific lock subsystem 470 (e.g., series of characters 212) and/or information about a date/time to generate a unique key code for a specific user. In various embodiments, the algorithm that generates key code information may be implemented by encoder 410, and/or by key service 440, and/or by an application hosted by a mobile device 105 associated with a guest who has made a reservation at a property, such as user 155.

As mentioned, the mobile device 105 associated with a guest/user 155 may execute a software application that user 155 downloaded from an app store 460, as is well known in the art. Also as mentioned, when executing, the software application may function to communicate with key service 440 and to accept input associated with and/or identifying user 155 (e.g., user identification information used to reserve a hotel room), and/or accept input associated with and/or identifying lock subsystem 470 (e.g., a hotel room number, information from a bar code 110, information from a character display 210, etc.), and to use the input to generate key information that opens a lock subsystem 470 associated with the property. And in various embodiments the key information may be represented as a series of digits on display screen 170 that user 155 punches into a key pad associated with lock subsystem 470 (such as key pad 115), may be represented as or in a bar code (such as key bar code 240) that is read by an image reader associated with lock subsystem 470 (such as image reader 220), or may be represented and communicated to a lock subsystem 470 in some other manner provided by mobile device 105 (such as an encoded RF or IR signal or numbers/letters/words played or spoken into a microphone of a speech recognition system associated with a lock subsystem 470).

In various embodiments, the software application on mobile device 105 may also pass information back to key service 440, which may in turn pass the information to PMS 420 and/or guest database 430, which may be accessible by PMS 420. For example, the software application on mobile device 105 may upload activity data or reports to key service 440 indicating that mobile device 105 has accessed or interacted with lock subsystem 470, perhaps including a time stamp.

In the embodiment shown, key service 440 is a system or program that communicates with PMS 420 and/or encoder 410 and with guest database 430 and with mobile device 105. In various implementations, key service 440 may be a network-based service, such as a web-based service or a cell-phone-network-based service. In various embodiments, key service 440 may function to fetch or receive access credentials or access data, (such as key bar code 240 or a key code series of characters 160 or information necessary to generate key bar code 240 or key code series of characters 160) from PMS 420 and/or encoder 410, and to provide the received access data, or data generated from it, to mobile device 105. In some embodiments, key service 440 may also fetch or receive branding data from PMS 420 and/or encoder 410, which branding data may identify a specific property brand (e.g., Hilton™ hotel, Carnival™ cruise line) that is employing system and method 400, and which branding data may be provided to mobile device 105 for display by a software app.

In various embodiments, key service 440 may also communicate with guest database 430, for example to store information received from PMS 420 and/or encoder 410, and/or to schedule access to lock subsystem 150 and to schedule notification to user 155/mobile device 105 of reservation confirmations and the like.

In the embodiment shown, SMS service 450 is a system or program that communicates with PMS 420 and/or encoder 410 and with guest database 430 and with mobile device 105. In various implementations, SMS service 450 may be a network-based service, such as a web-based service or a cell-phone-network-based service. In various embodiments, SMS service 450 may function to fetch or receive guest or user notification information from guest database 430, and form that information into a message, such as a text message or multimedia message, that is transmitted to user device 105, such as a cell phone, which is associated with user 155. In various embodiments, the message may provide user 155 with information relevant to a property hosting lock subsystem 470, such as hotel reservation information, room or cabin number, check-in time and date, etc.

One of ordinary skill will recognize that elements, features, communication links, and functionality may be added to, removed from, or modified for system 400 shown in FIG. 4, without departing from the principles of the invention. For example, mobile device 105 could communicate with key service 440, SMS service 450, and App store 460 via network 180 or via another network (not shown). For another example, the functionality of key service 440 could be moved to PMS 420 such that key service 440 could be eliminated as a separate entity in system 400.

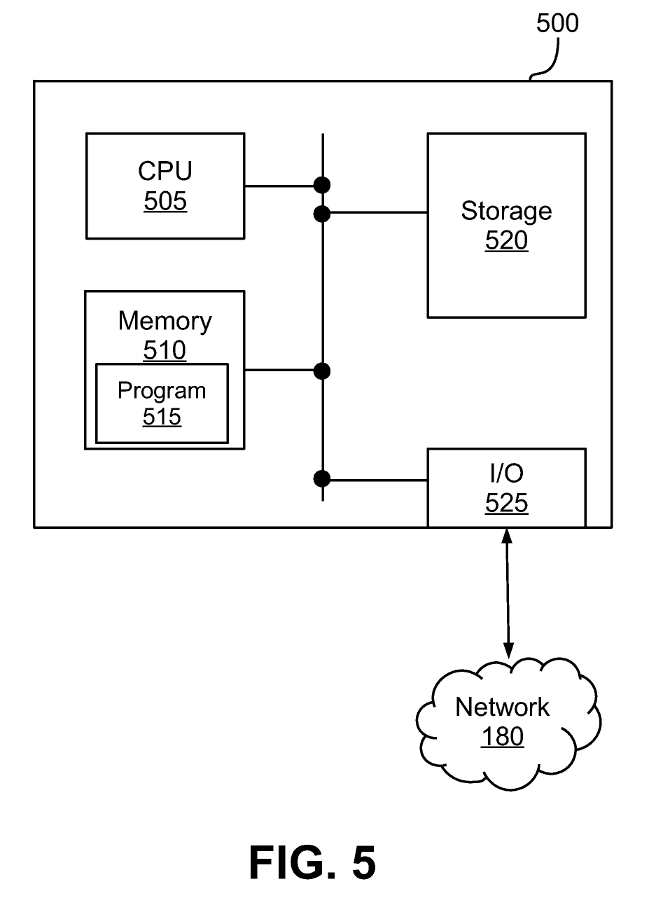

FIG. 5 is a block diagram of an exemplary computing system or data processing system 500 that may be used to implement embodiments consistent with the invention. Other components and/or arrangements may also be used. In some embodiments, computing system 500 may be part of an electronic device, such as mobile device 105, a smart phone, a tablet computer, a gaming device, a music playing device, etc.

Computing system 500 includes a number of components, such as a central processing unit (CPU) 505, a memory 510, an input/output (I/O) device(s) 525, and a nonvolatile storage device 520. System 500 can be implemented in various ways. For example, an implementation as an integrated platform (such as a laptop computer, a tablet computer, a netbook computer, a smart phone, a gaming device, a personal digital assistance device, etc.) may comprise CPU 505, memory 510, nonvolatile storage 520, and I/O devices 525. In such a configuration, components 505, 510, 520, and 525 may connect and communicate through a local data bus. I/O component(s) 525 may connect to external devices through a direct communication link (e.g., a hardwired, local wifi, or telephonic connection), through a network 180, such as a local area network (LAN) or a wide area network (WAN, the Internet, etc.), and/or through other suitable connections. System 500 may be standalone or it may be a subsystem of a larger system or device.

CPU 505 may be one or more known processing devices, such as a microprocessor from the Core™ 2 family manufactured by the Intel™ Corporation of Santa Clara, Calif., and the like. Memory 510 may be one or more fast solid-state devices configured to store instructions and information used and/or executed by CPU 505 to perform certain functions, methods, and processes related to embodiments of the present invention. Storage 520 may be a volatile or non-volatile, magnetic, semiconductor, tape, optical, or other type of storage device or computer-readable storage medium, including devices such as solid state memories, EEPROMS, hard disks, CDs and DVDs, meant for long-term storage.

In the illustrated embodiment, memory 510 contains one or more software applications (a.k.a. apps), programs, or subprograms 515, which may be loaded from storage 520 or from a remote system (not shown) that, when executed by CPU 505, perform various operations, procedures, processes, or methods consistent with the present invention. Alternatively, CPU 505 may execute one or more applications or programs located remotely from system 500. For example, system 500 may access one or more remote programs via network 180 that, when executed, perform functions and processes related to or implementing embodiments of the present invention.

In some embodiments, memory 510 may include an app(s) or program(s) 515 for generating key code characters or images that contain key code information, such as QR bar code images. For example, memory 510 may include an app(s) or program(s) 515 that implements the functionality of the software application executing on mobile device 105 as described with respect to FIGS. 1-4. For another example, memory 510 may include an app(s) or program(s) 515 that implements the functionality of key service 440 as described with respect to FIG. 4. In some embodiments, memory 510 may also include other programs, subprograms, or applications that implement other methods and processes that provide ancillary functionality to the invention. For example, memory 510 may include subprograms that gather, from various subsystems and external secondary devices, information relating to a user 155 and mobile device 105, including, for instance, name, phone number, reservation number, credit card or other payment information, etc.

Memory 510 may be also be configured with other programs (not shown) unrelated to the invention and/or an operating system (not shown) that performs several functions well known in the art when executed by CPU 505. By way of example, the operating system may be Android™ operating system, Linux™ operating system, an Apple Computers™ operating system, or other operating system. The choice of operating system, and even to the use of an operating system, is not critical to the invention.

I/O device(s) 525 may comprise one or more input/output devices that allow data to be received and/or transmitted by system 500. For example, I/O device 525 may include one or more input devices, such as a keyboard, touch screen, mouse, microphone, camera, and the like, that enable data to be input from outside sources, including a user, such as a primary user 155 (e.g., owner) of a mobile device 105. Further, I/O device 525 may include one or more output devices, such as a display screen, LCD screen, plasma display, speaker devices, and the like, that enable data to be output or presented to a user. I/O device 525 may also include one or more digital and/or analog communication input/output devices that allow computing system 500 to communicate, for example, digitally, with other machines and devices. For example, in the case of a smart phone or similar device, I/O device 525 may include a wireless communication subsystem, such as a cell phone network communication subsystem and/or Bluetooth® communication subsystem, that allows system 500 to communicate with other Bluetooth® devices, web services, etc. Other configurations and/or numbers of input and/or output devices may be incorporated in I/O device 525.

In the embodiment shown, system 500 is connected to a network 180 (such as a cell phone network, telephone network, the Internet, a private network, a virtual private network, or other network), which may in turn be connected to various systems, devices, and/or computing machines (not shown in FIG. 5). In general, system 500 may input data from external machines and devices and output data to external machines and devices via network 180.

The foregoing disclosure provides examples of systems and methods for providing an electronic key (e.g., a key code or key-code-bearing image) to a user having a common mobile device, such as a cell phone. It will be apparent to those skilled in the art that various modifications and variations can be made to the structures and methodologies described herein. For example, it will be apparent to those skilled in the art that the visual interfacing between the lock subsystem and the mobile device (e.g., mobile device scans bar code or series of digits from lock subsystem; user reads and enters into phone series of digits from lock subsystem; lock subsystem scans bar code displayed by mobile device, etc.) may be replaced by RF interfacing between the mobile device and lock subsystem to communication the same information via a different medium. For another example, it will be apparent to those skilled in the art that the interfacing between the mobile device (and user) and the lock subsystem may be replaced by similar interfacing between the mobile device (and user) and a terminal, kiosk, station, etc. located any distance from the lock, for example, in a hotel lobby, such that the key code information or the information needed for the mobile device to generate the key code or key bar code image is obtained from the terminal, kiosk, station, etc., and the key code or key bar code image, which is stored by the mobile device, is subsequently used at the lock.

Thus, it should be understood that the invention is not limited to the examples discussed in the specification. Rather, the present invention is intended to cover modifications and variations.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims. Moreover, the claims can encompass embodiments in hardware, software, or a combination thereof.

What is claimed is:

1. A method for opening an electronically controlled lock by a user, the method comprising:
obtaining user information that identifies the user;
obtaining lock information that identifies the electronically controlled lock;
creating key information based on the user information and the lock information; and
displaying the key information on a mobile device, wherein the key information is received by the electronically controlled lock and processed to open the electronically controlled lock.

2. The method of claim 1, wherein obtaining lock information that identifies the electronically controlled lock comprises:
receiving an image associated with the electronically controlled lock; and
processing the image to extract the lock information.

3. The method of claim 2, wherein the image is an image of a bar code.

4. The method of claim 1, wherein obtaining lock information that identifies the electronically controlled lock comprises:
receiving a series of characters associated with the electronically controlled lock.

5. The method of claim 1, wherein creating key information based on the user information and the lock information comprises:
calculating a series of characters using the user information and the lock information;
wherein the series of characters is a key code that opens the electronically controlled lock when entered via a key pad to the electronically controlled lock.

6. The method of claim 1, wherein creating key information based on the user information and the lock information comprises:
calculating a key code using the user information and the lock information; and
encoding the key code into an image;
wherein the key code opens the electronically controlled lock.

7. The method of claim 6, wherein the image is an image of a bar code.

8. The method of claim 1, wherein displaying the key information on a mobile device comprises:
displaying a series of characters on the mobile device;
wherein the series of characters is a key code that opens the electronically controlled lock when entered via a key pad to the electronically controlled lock.

9. The method of claim 1, wherein displaying the key information on a mobile device comprises:
displaying an image on the mobile device;
wherein the image includes a key code that opens the electronically controlled lock.

10. The method of claim 9, wherein the image is an image of a bar code.

11. The method of claim 1, further comprising:
sending information from the mobile device indicating that the lock information that identifies the electronically controlled lock has been obtained.

12. A non-transitory computer-readable medium including instructions that, when executed by a processor, implement operations for opening an electronically controlled lock by a user, the operations comprising:
obtaining user information that identifies the user;
obtaining lock information that identifies the electronically controlled lock;
creating key information based on the user information and the lock information;
displaying the key information on a mobile device, wherein the key information is received by the electronically controlled lock and processed to open the electronically controlled lock.

13. The non-transitory computer-readable medium of claim 12, the operations further comprising:
sending information indicating that the lock information that identifies the electronically controlled lock has been obtained.

14. An electronic lock comprising:
a display that includes lock information that identifies the electronic lock to a mobile device;
a key information receptor that receives key information displayed by the mobile device; and
a processor, operably connected to the key information receptor, wherein the processor determines whether the key information is currently valid for opening the electronic lock; and
a lock actuator circuit, operably connected to the processor, that opens the electronic lock based on a signal from the processor indicating that the key information is currently valid for opening the electronic lock.

15. The electronic lock of claim 14, wherein the display comprises:
an image of a bar code.

16. The electronic lock of claim 14, wherein the display comprises:
a character display device.

17. The electronic lock of claim 14, wherein the key information receptor comprises:
a key pad.

18. The electronic lock of claim 14, wherein the key information receptor comprises:
an image capturing device.

19. The electronic lock of claim 18, wherein the image capturing device comprises:
a bar code scanner.

20. The electronic lock of claim 14, wherein the mobile device transmits information indicating that the mobile device has received the lock information that identifies the electronic lock.
